(19) United States
(12) Patent Application Publication
(10) Pub. No.: US 2011/0009511 A1
(43) Pub. Date: Jan. 13, 2011

(54) Glass Polycarboxylate Cements

(75) Inventors: Robert Graham Hill, Maidenhead (GB); Molly Morag Stevens, London (GB)

Correspondence Address: Pepper Hamilton LLP, 400 Berwyn Park, 899 Cassatt Road, Berwyn, PA, 19312-1183, US

(73) Assignee: IMPERIAL INNOVATIONS LIMITED, London (GB)

(21) Appl. No.: 12/667,548

(22) PCT Filed: Jul. 2, 2008
(86) PCT No.: PCT/GB2008/002301

§ 371 Date: Sep. 25, 2010

(30) Foreign Application Priority Data
Jul. 5, 2007 (GB) 0713094.1

(51) Int. Cl. C08K 3/32; C08K 3/22; C03C 3/097; C03C 3/078; C03C 3/062; C03C 3/066; C03C 3/064; C03C 3/089; C08K 3/26

(52) U.S. Cl. 521/92; 524/433; 501/63; 501/72; 501/73; 501/79; 501/77; 501/65; 524/414

(57) ABSTRACT

The present invention relates to glass compositions for use in formation of polycarboxylate cements and polycarboxylate cements comprising these glasses, wherein the glasses comprise SiO₂ and MgO, with a molar percentage of SiO₂ not exceeding 60% and a molar percentage of MgO being greater than 20%.

The present invention relates to glass compositions for use in formation a polycarboxylate cements and polycarboxylate cements comprising these glasses.

Glass (ionomer) polyalkenoate cements (also known as poly(carboxylate) or poly(carboxylic acid) cements) are formed by acid-base reaction of a polymer containing free carboxylic acid groups (a poly(carboxylic acid) such as poly(acrylic acid) with an acid leachable source of polyvalent metal ions (e.g a degradable fluoro-alumino-silicate glass powder). Cements formed by reacting fluoro-alumino-silicate glass powder with a poly (carboxylic acid) are well known in the art (U.S. Pat. No. 3,814,717). The poly(carboxylic acid) and glass are reacted in the presence of water. Metal cations released from the glass ionically bond with carboxylate groups of the poly(carboxylic acid) thereby crosslinking the polymer chains to give a solid cement. The products of the acid-base reaction are a silica gel type phase and a polymeric salt.

Poly(carboxylic acid) cements comprising fluoro-alumino-silicate glasses have found widespread use in dentistry as restorative filling materials for tooth restoration, as fissure sealants and as adhesives. Similar to bioactive glasses, poly(carboxylate) cements comprising fluoro-alumino-silicate glasses release silicon in soluble form as well as calcium and phosphate ions that stimulate osteoblasts. Despite this, they have found only limited application in medicine as bone adhesives and bone substitutes. This is despite their attractive properties, such as high strength, fast setting behaviour and chemical adhesion to bone, via carboxylate chelation of calcium ions in the apatite mineral phase. This is largely because low levels of aluminium are released from the set cement which results in defective bone mineralisation and osteoid formation at the bone-cement interface.

A biologically active (or bioactive) glass is a glass which, when implanted into a living tissue such as bone, induces formation of an interfacial bond between the glass and the tissue. Bioactivity was first observed in soda-calcia-phospho-silica (SiO₂—P₂O₅—CaO—Na₂O) glasses (Hench et al., J. Biomed. Mater. Res. Symp. 2(1):117-141 (1971)). Bioactivity is a result of a series of physiochemical reactions on the surface of a glass under physiological conditions, loading to the generation of a crystalline hydroxycarbonated apatite (HCA) layer on the glass surface. The rate of development of the HCA layer provides an in vitro index of bioactivity.

Moreover, known glass (ionomer) polycarboxylate cements comprising fluoro-alumino-silicate glasses are non-degradeable in the body. This can be a drawback for some applications. For example, in the case of an adhesive bone cement for repair of bone fractures, non-degradability is a disadvantage. In contrast, for use in the fixation of cochlear implants where permanent fixation is required, a non-degradable cement is advantageous.

The presence of aluminium in a glass composition was thought originally to be critical for cement formation. (Hill R. G. and Wilson A. D., Glass Technology 29:150-158 (1988)). Al₂O₃ content in glasses not only provides Al³⁺ cations for cross-linking but also binds fluorine in the glass, thus preventing the formation of SiF bonds and preventing loss of volatile silicon tetrafluoride (SiF₄). Despite this, there have been a number of attempts to develop aluminium-free glass poly(carboxylic acid) cements. Cements have been developed based on M₂O—ZnO—SiO₂ glasses where M is a divalent metal cation (Hill R. G. and Darling M., Biomaterials 15:299-306 (1994) and GB 2310663A), on SrO—CaO—ZnO—SiO₂ glasses (WO 2007/020613A1) and on fluoro-alumino-silicate glass compositions in which Al₂O₃ is replaced with Fe₂O₃ (WO 2003/028670A). Replacing Al₂O₃ by Fe₂O₃, however, leads to the drawback of uncontrolled loss of SiF₄. Furthermore, it is difficult to prevent the reduction of Fe³⁺ to Fe²⁺ during melting, which results in the uncontrolled crystallisation of Fe₃O₄ from the glass. This results in poor control over the properties of the final product which is particularly important when it is intended for use as a medical device.

Zinc containing cements with high zinc contents generally result in significant zinc release in use. Whilst low level zinc release is known to stimulate bone formation, high zinc contents leading to significant zinc release are deleterious and cytotoxic. Furthermore, at high concentrations zinc is known to inhibit HCA deposition from simulated body fluid. Zinc is thought to poison apatite crystal growth by binding to calcium sites on the surface of apatite crystals and therefore acts to inhibit mineralisation. In the case of cements designed to be degradable in the body, glasses with high zinc contents are even more undesirable because degradation increases zinc release.

There is therefore a need in the art for improved glass compositions for use in the formulation of poly(carboxylate) cements which are suitable for a variety of medical applications, including bone adhesion and substitution.

The present invention relates to i) novel aluminium-free bioactive glass compositions suitable for cement formation with carboxyl-containing, water soluble polymers; ii) cement compositions comprising a novel aluminium-free bioactive glass and based on an enzymatically degradable polycarboxylic acid (for example poly(gamma glutamic acid)) and iii) cement compositions comprising a novel aluminium-free bioactive glass and based on non-degradable polyacids.

In silica based glasses, SiO₂ forms the amorphous network of the glass, and the molar percentage of SiO₂ in the glass affects its Network Connectivity (NC). NC is the average number of bridging bonds per network forming element in the glass structure. NC determines glass properties such as viscosity, crystallisation rate and degradability. At a NC of 2.0 it is thought that linear silicate chains exist of infinite molar mass. As NC falls below 2.0, there is a rapid decrease in molar mass and chain length. Above an NC of 2.0, the glass becomes a three dimensional network. The inventors have determined that in highly disrupted bioactive glasses of low network connectivity (corresponding to SiO₂ contents <60 mole %), the incorporation of MgO (substituted for CaO) increases NC due to a proportion of the MgO becoming incorporated into the silicate glass network. This is contrary to established beliefs that MgO acts as a network modifier, disrupting the glass network. The increase in NC accompanying substitution of MgO for CaO and would generally be expected to decrease the reactivity of the glass since MgO is acting to crosslink the glass network. However, the introduction of Mg—O—Si bonds into the glass network is thought to provide bonds capable of undergoing acid hydrolysis in an analogous manner to incorporating Al₂O₃ in conventional fluoro-alumino-silicate glasses for forming glass (ionomer) poly(carboxylic acid) cements. In fluoro-alumino-silicate glasses, acid degradability is determined largely by the number of Al—O—Si bonds in the glass network and therefore by the ratio of Al:Si in the glass composition. NC is of secondary importance. Thus, the inventors have determined that, contrary to established beliefs, the incorporation of a high proportion of MgO into a glass allows the provision of a glass particularly suited to use in the formulation of poly(carboxylic acid) cements, whilst avoiding drawbacks of ZnO and Al₂O₃ containing glasses.

Moreover, the presence of MgO in a cement formulation improves hydrolytic stability of the cement. This is because the Mg²⁺ cation is smaller than the Ca²⁺ cation and therefore gives more efficient ionic cross-linking. The incorporation of Mg into the glass network will reduce the degradation and bioactivity of the glass under neutral or basic condition by increasing NC, but will increase the acid degradability of the glass under acidic conditions. Furthermore, incorporation of MgO will tend to facilitate melting and aid glass stability ie glasses will be less likely to crystallise during quenching.

Therefore, in a first aspect, the present invention provides a poly(carboxylic acid) cement formed from a water soluble poly (carboxylic acid) and an aluminium-free glass comprising SiO₂ and MgO, wherein within the glass the molar percentage of SiO₂ does not exceed 60% and the molar percentage of MgO is greater than 20%.

Glass compositions which are of use in forming a poly(carboxylic acid) cement of the invention are described in detail below.

The cement may be enzymatically degradable or non-degradable under physiological conditions. This is determined by the poly(carboxylic acid), or mixture thereof, use in cement formation.

In a preferred embodiment, the poly(carboxylic acid) is a synthetic poly(carboxylic acid), including but not limited to poly(acrylic acid), poly(aspartic acid), poly-(glutamic acid), poly(maleic acid), poly(itaconic acid), poly(vinyl phosphonic acid) or any copolymer poly(carboxylic acid) based on two or more of the above. Preferably, synthetic poly(carboxylic acid) has a molar mass below 15,000, such that it is capable of being excreted from the body via the kidneys where a degradeable cement is required. Poly(acrylic acid) cements are non-chemically degradable. Cements based on the other polyacids listed above, or their mixtures with poly(acrylic acid), display varying degrees of dissolution. In applications where a non degradable cement is required for example vertebroplasty or kyphoplasty a higher molar mass >50,000 is desirable.

In another preferred embodiment, the poly(carboxylic acid) is poly(gamma glutamic acid). Poly(gamma glutamic acid) is a water soluble polypeptide synthesized by bacteria and having a molecular weight between 2,000 and 400,000 (preferably between 10,000 and 200,000). A particularly preferred source of poly(gamma glutamic acid) is that produced by bacillus lichenformis. A cement formed from poly(gamma glutamic acid) will be enzymatically degradable under physiological conditions.

Preferably, the cement comprises a mixture of a synthetic poly(carboxylic acid) and poly(gamma glutamic acid). Preferably, the cement is a degradable cement formed from poly(gamma glutamic acid) of molar mass >100,000 in combination with one or more multi functional poly(carboxylic acids) of molar mass less than 15,000. A multi functional carboxylic acid is a carboxylic acid having two or more functional groups, for example tartaric acid or citric acid.

More preferably, the degradable cement is formed from poly(gamma glutamic acid), poly(glutamic acid) and poly(aspartic acid).

In a preferred embodiment, a cement of the invention comprises a water soluble antibiotic such as gentomycin and/or a biological therapeutic agent such as a bone morphogenic protein.

It will be appreciated that the cement as defined above comprises a glass which may included additional components, thereby providing a cement that may release beneficial ions, such as Sr²⁺, F⁻, PO₄³⁻ etc.

In a preferred embodiment, a degradable cement as defined above is for use as bone cement, adhesive or bone substitute. The cement may be used in procedures such as vertebroplasty, kyphoplasty and for the treatment of osteoporosis and osteoporotic fractures.

In a preferred embodiment, a non degradable cement as defined above may be used as a bone cement or bone substitute.

An aluminium-free glass for use in the formation of a polycarboxylate cement, comprises SiO₂ and MgO, wherein the molar percentage of SiO₂ does not exceed 60% and wherein the molar percentage of MgO is greater than 20%.

Thus, in a second aspect, the present invention provides an aluminium free glass for use in the formation of a poly(carboxylic acid) cement, the glass comprising:

30-60 mol % SiO₂

21-50 mol % MgO,

0-6 mol % Na₂O

a combined CaO and SrO content of O-40 mol %; and

0-5 mol % P₂O₅.

The percentage contents of glass compositions as referred to throughout are molar percentages. Metal oxides used in formation of glass compositions provide a source of the respective metal ions. Where a glass is recited as comprising a certain percentage of the oxide, during formation of the glass, the oxide itself may be provided or a compound that decomposes to form the oxide may be provided.

The source of MgO used in preparation of a glass of the present invention is preferably magnesium oxide (MgO), magnesium carbonate (MgCO₃), magnesium nitrate (Mg(NO₃)₂), magnesium sulphate (MgSO₄), a magnesium silicate or any such compound that decomposes to form magnesium oxide. Preferably, the glass comprises 21-50 mole % MgO, more preferably 21-40 mole %, even more preferably 21-38 mole %.

For applications where hydrolytic stability of particular importance a high MgO content, for example of 33-38 mol %, is desirable. Where bioactivity is of key importance, a lower MgO content, for example of 21-33 mol % can be desirable as MgO can have some inhibitory activity of apatite crystal growth.

In a preferred embodiment, the glass is a melt-derived glass with a molar percentage of SiO₂ that does not exceed 60%. The melt-derived glass is preferably prepared by mixing and blending grains of the appropriate oxides (or sources of the oxides, such as carbonates), heating to melting temperature and homogenising the mixture at temperatures of approximately 1250° C. to 1500° C. Homogenisation is preferably performed by oxygen bubbling. The mixture is then coded, preferably by casting the molten mixture into a suitable liquid such as deionised water, to produce a glass fit. Preferably, the molar percentage of SiO₂ is 30% to 60%, preferably 40% to 60%, more preferably 40% to 55%. Preferably, the molar percentage of SiO₂ does not exceed 53% (e.g. is from 30%-53%).

In a preferred embodiment, the NC of a glass according to the invention is below 3.0, preferably below 2.5. Preferably, the glass has a silica mole percent less than 55% and an NC below 2.4. Preferred compositions generally have a silica mole percent lower than 55% and a calculated network connectivity of below 2.0. These formulations favour a higher proportion of the MgO acting as an intermediate oxide which in turn is thought to aid acid degradation of the glass. The NC values are calculated assuming the MgO is acting as a network modifying oxide.

Network connectivity can be calculated according to the method set out in Hill R., J. Mater. Sci. Letts, 15 1122-25 (1996), but with the assumption that where phosphate is included in the glass composition, phosphate forms a second phase and is not part of the silicate glass network. The phosphate exists as a separate orthophosphate phase and removes network modifying cations from the silicate phase to maintain charge neutrality.

In a preferred embodiment, the glass is a bioactive glass. Preferably, the glass comprises one or more of the following properties: on exposure of the glass to simulated body fluid (SBF), deposition of a HCA layer occurs within 3 days; the glass is capable of stimulating mineralization and/or osteoblast activity in culture; the glass provides an intimate interface in vivo, i.e. on in vivo implantation in an animal model, fibrous capsule layer formation is absent.

In a preferred embodiment, the glass comprises one or more additional components selected from a source of strontium, calcium, phosphate, zinc, fluorine, boron or an alkali metal such as sodium or potassium.

Preferably the source of the additional component is one or more of the compounds including but not limited to sodium oxide (Na₂O), sodium carbonate (Na₂CO₃), sodium nitrate (NaNO₃), sodium sulphate (Na₂SO₄), sodium silicates, potassium oxide (K₂O), potassium carbonate (K₂CO₃), potassium nitrate (KNO₃), potassium sulphate (K₂SO₄), potassium silicates, calcium oxide (CaO), calcium carbonate (CaCO₃), calcium nitrate (Ca(NO₃)₂), calcium sulphate (CaSO₄), calcium silicates, zinc oxide (ZnO), zinc carbonate (ZnCO₃), zinc nitrate (Zn(NO₃)₂), zinc sulphate (ZnSO₄), and zinc silicates and any such compounds, including acetates of sodium, potassium, calcium or zinc, that decompose to form an oxide.

Preferably, the glass comprises a source of strontium. The strontium may be provided in the form of strontium oxide (SrO) or a source of SrO. A source of SrO is any form of strontium which decomposes during glass formation to form SrO, including but not limited to SrCO₃, SrNO₃, Sr(CH₃CO₂)₂ and SrSO₄. Strontium may also be provided as SrF₂, Sr₃(PO₄) or strontium silicate. Release of strontium from a glass has a stimulatory effect on osteoblasts and an inhibitory effect on osteoclasts.

Preferably, the glass comprises Sr²⁺ (for example calculated as SrO) at a molar percentage of at least 1%, preferably 1 to 30%, more preferably 1 to 20%, even more preferable 1 to 10%. Alternatively, the glass may be strontium free.

Preferably, the glass comprises a source of sodium ions (Na⁺), preferably sodium oxide (Na₂O) or a source of sodium oxide. The source of sodium ions used in preparation of the glass may be, for example, sodium oxide, sodium carbonate (Na₂CO₃), sodium nitrate (NaNO₃), sodium sulphate (Na₂SO₄) or a sodium silicate. The molar percentage of the source of sodium ions within the glass (preferably Na₂O) is preferably 0-10%, more preferably 0-6%. Preferably, at least 1% is present.

Preferably, the glass comprises a source of potassium ions, preferably in the form of potassium oxide (K₂O). The source of potassium ions used in preparation of the glass may be, for example, potassium oxide (K₂O), potassium carbonate (K₂CO₃), potassium nitrate (KNO₃), potassium sulphate (K₂SO₄) or a potassium silicate. The molar percentage of the source of potassium ions within the glass (calculated as K₂O) is preferably 0 to 10%, 0 to 7%, or 3 to 7%. Preferably, at least 1% is present.

The inclusion of a small amount of one or more sources of alkali metal is desirable to facilitate melting. However, alkali metal ions inhibit the ionic cross-linking of carboxylate groups and tend to confer undesirable solubility on the cement. It is therefore preferable to have low alkali metal content. Preferably the combined molar percentage of the sources of potassium (e.g. calculated as K₂O) and sodium (e.g. calculated as Na₂O) is up to 10%, preferably up to 6%. It is desirable for the melting temperature of the glass to be kept low. A preferred glass composition which achieves dropping of the melting temperature comprises a low alkali metal content of no more than 6 mol % (preferably comprising no Na₂O) and a source of fluorine. Preferably the source of fluorine is provided at up to 10 mol %.

Preferably, the glass should have a silica mole percent below 60%, a low NC below 3.0 (and preferably below 2.5) and a low alkali metal content (preferably below 10 mole percent and preferably zero). In general, it is desirable to have a glass with a silica mole percent less than 55% and a NC below 2.4.

In certain embodiments, the glass comprises at least 10 mole % SrO, thereby providing the glass with a radio-opacity equivalent to at least 1 mm of Al.

Preferably, the glass comprises a source of calcium, preferably in the form of calcium oxide (CaO). The source of calcium used in the preparation of the glass is, for example, calcium oxide (CaO), calcium carbonate (CaCO₃), calcium nitrate (Ca(NO₃)₂), calcium sulphate (CaSO₄), calcium silicates or a source of calcium oxide. For the purposes of this invention, a source of calcium oxide includes any compound that decomposes to form calcium oxide. For the purposes of this invention, glasses containing no calcium can be used. Preferably, the molar percentage of the source of calcium (e.g. calculated as CaO) is 0% to 30%, 0% to 25% or 0% to 20%. Preferably, the combined molar percentage of CaO and SrO is 0% to 40%, preferably, 10% to 30%.

The glass of the present invention preferably comprises P₂O₅. Preferably, the molar percentage of P₂O₅ is 0% to 5%, more preferably 1% to 3%. P₂O₅ is believed to have a beneficial effect on the viscosity-temperature dependence of the glass, increasing the working temperature range which is advantageous for the manufacture and formation of the glass. Adding P₂O₅ on its own to the glass can act to remove cations from the silicate phase, thereby increasing NC and reducing degradability. However, adding P₂O₅ with additional modifying oxide, i.e. MgO acting as an intermediate oxide, keeps NC constant.

The glass of the present invention preferably comprises a source of zinc, preferably in the form of zinc oxide (ZnO) or zinc fluoride (ZnF₂). The source of zinc used in the preparation of the glass is, for example, zinc oxide (ZnO), zinc fluoride (ZnF₂), zinc carbonate (ZnCO₃), zinc nitrate (Zn(NO₃)₂), zinc sulphate (ZnSO₄), zinc silicate or any such compound that decomposes to form zinc oxide. At low concentrations, zinc is desirable because it improves cement stability and low level zinc release promotes wound healing and aids the repair and reconstruction of damaged bone tissue. However, at high concentrations, zinc can reduce bioactivity, inhibiting HCA deposition. Moreover, high level zinc release can be cytotoxic and can favour fibrous capsular formation at the cement-bone interface. Therefore, the source of zinc is preferably present at a molar percentage of no more than 25%, preferably at a molar percentage of no more than 5% if the cement is a degradable cement. Preferably, the molar percentage of the zinc source (preferably ZnO or ZnF₂) is 0% to 25%, 0% to 20%, 0% to 15% or 0% to 10% or 0% to 5%.

The bioactive glass of the present invention preferably comprises boron, preferably as B₂O₃. As with P₂O₅, B₂O₃ is believed to have a beneficial effect on the viscosity-temperature dependence of the glass, increasing the working temperature range which is advantageous for the manufacture and formation of the glass. Preferably, the molar percentage of B₂O₃ is 0% to 15%. More preferably, the molar percentage of B₂O₃ is 0% to 12%, or 0% to 2%.

The bioactive glass of the present invention preferably comprises a source of fluoride. Preferably, fluorine is provided in the form of one or more of calcium fluoride (CaF₂), strontium fluoride (SrF₂), magnesium fluoride (MgF₂), zinc fluoride (ZnF₂), Sodium fluoride (NaF) or potassium fluoride (KF). Fluorides can be used to lower the melting temperature and hence can be used in addition or as an alternative to alkali metals Fluorides also stimulate osteoblasts and increase the rate of hydroxycarbonated apatite deposition. Fluoride and strontium act synergistically in this regard. Preferably, the fluorine is provided in a molar percentage of 0% to 25%. Preferably, the source of fluorine is provided in a molar percentage of 0% to 10%, or 1% to 7%.

In a preferred embodiment, the glass has the molar composition YSiO₂:(Z—X)CaO+SrO:XMgO:6Na₂O, wherein X is more than 20 (preferably 21-44), Y is 45-50 and Z is 44-49. More preferably, the composition is 45SiO₂:(49-X)CaO+SrO:XMgO:6Na₂O or 50SiO₂:(44-X)CaO:XMgO:6Na₂O.

In a preferred embodiment, a glass of the invention is provided in particulate form. Preferably, the particle size is less than 100 microns (maximum dimension).

In a preferred embodiment, the glass (preferably in particulate/powder form) is acid treated. Treatment of the glass with an acid prior to cement formation acts to remove a proportion of cations from the glass surface thereby slowing the initial setting process during poly(carboxylate) cement formation. Preferably, the acid used is acetic acid, preferably in a 1-5% aqueous solution. The glass powder is suspended in an acid solution and agitated (e.g. for 30 minutes), following which the acid is neutralised, the glass is allowed to settle, the liquid decanted off and the glass powder is washed and dried.

A glass of the second aspect of the invention may be used to form a cement of the first aspect of the invention. Thus, the invention provides a poly(carboxylic acid) cement of any embodiment of the first aspect of the invention wherein the aluminium-free glass is a glass of any embodiment of the second aspect of the invention.

In a third aspect, the present invention provides a method for preparing a poly(carboxylic acid) cement comprising mixing an aluminium-free glass comprising SiO₂ and MgO, wherein within the glass the molar percentage of SiO₂ does not exceed 60% and the molar percentage of MgO is greater than 20% in powder form, with a water soluble poly(carboxylic acid) in the presence of water. In a preferred embodiment the ratio by mass of poly(carboxylic acid) to water is at least 1:9 and less than 2:1 and preferably close to 1:1.

Preferably, the glass is as defined in respect of the second aspect of the invention.

Preferably, the ratio by mass of glass to poly(carboxylic acid) is at least 1:2 and less than 20:1 and is preferably in the range 3:1 to 9:1.

In a preferred embodiment, the method comprises the step of annealing the glass powder by heating to its glass transition temperature and subsequently cooling the glass before mixing the glass with the poly (carboxylic acid). The acid-base reaction that occurs during cement formation is exothermic and annealing the glass acts to reduce glass reactivity and slow the cement formation where an increased setting time is required.

Preferably, the cement is moulded, for example by lost wax casting, and set prior to implantation. Preferably, the cement is thermally cured by autoclaving, boiling or microwaving, to improve its mechanical properties.

In a fourth aspect, the present invention provides a degradable scaffold comprising a cement as defined herein, wherein 0.1 to 5% by weight of a metal carbonate, preferably an alkaline earth carbonate such as CaCO₃, SrCO₃, or ZnCO₃ is added to the glass powder, prior to forming the cement in order to generate carbon dioxide and produce a foamed cement with interconnected pores preferably of size greater than 100 microns.

All preferred features of each of the aspects of the invention apply to all other aspects mutatis mutandis.

The invention may be put into practice in various ways and a number of specific embodiments will be described by way of example to illustrate the invention with reference to the accompanying drawings, in which:

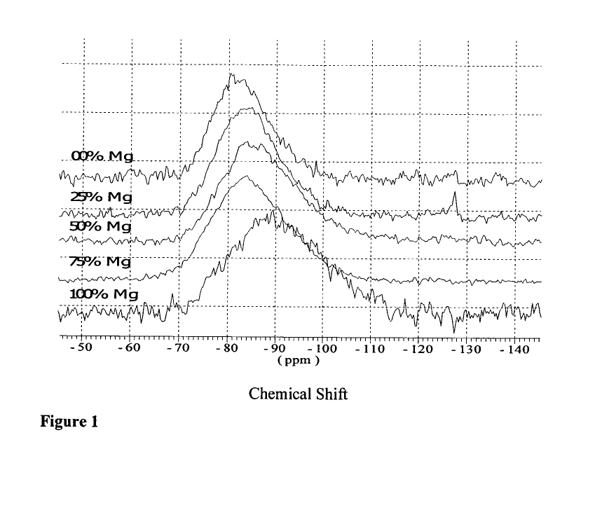

FIG. 1 shows a series of ²⁹Si MAS-NMR spectra of glasses from the series 50SiO_{2:}(44-X)CaO:XMgO:6Na₂O where the percentage represents the percentage of CaO replaced by MgO and the shift in the peak to more negative values is indicative of a more cross-linked glass of higher network connectivity.

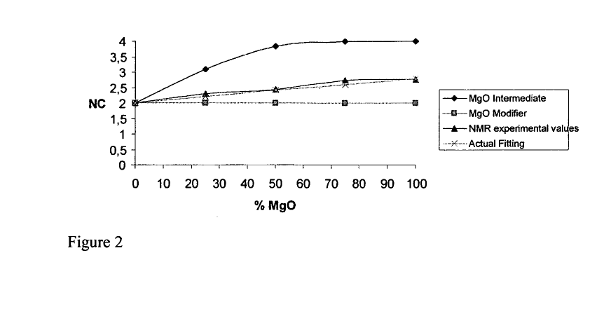

FIG. 2 shows calculated and experimental network connectivity values for the series of glasses of FIG. 2 plotted against the MgO content for instances where MgO acts as either i) a network modifying oxide ii) an intermediate oxide or iii) where 17% of the MgO acts as an intermediate oxide (as calculated from MAS-NMR measurements).

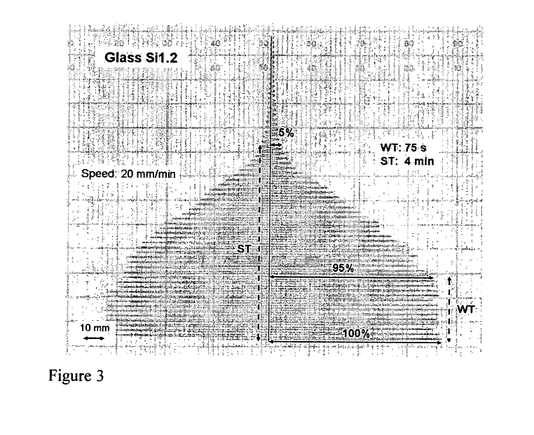

FIG. 3 shows an oscillating rheometer trace defining the working time (WT) and setting time (ST) of a poly acid cement formed from poly(acrylic acid) and glass example 26.

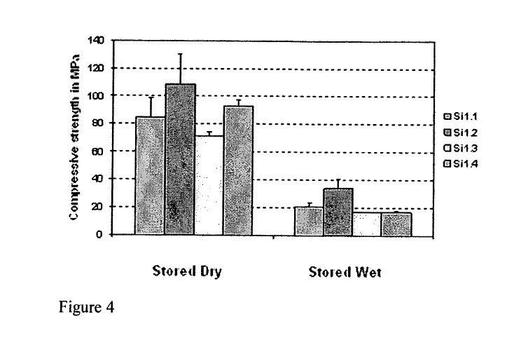

FIG. 4 shows the compressive strength of cement examples 7-10 made with glass examples 25-28 (listed in the figure as glasses Si1.1-1.4, respectively), which have varying SiO₂ content.

Studies on bioactivity of MgO containing glasses have lead to a finding that, contrary to previous views, MgO becomes incorporated into a silicate glass network. This has lead to determination that the glass compositions with high MgO levels of the invention are of particular useful for forming poly(carboxylic acid) cements.

The previously accepted mechanism for the degradation and bioactivity of melt derived bioactive glasses is summarised in Scheme 1, shown below:

Scheme 1

Step 1

Rapid exchange of Na+ with H+ or H₃O+ from solution.

Si—O—Na++H+OH—→Si—OH+Na+(solution)+OH—

Step 2

Loss of soluble silica in the form of Si(OH)₄ to the solution resulting from alkaline hydrolysis of Si—O—Si bonds and formation of Si—OH (silanol) groups at the glass solution interface.

2(Si—O—Si)+2(OH—)→SiOH+OH—Si

Stage 3

Condensation and re-polymerisation of a SiO₂ rich layer on the surface depleted in alkalis and alkaline earth cations

2(Si—OH)+2(OH—Si)→Si—O—Si—O—Si—O—Si—O

Stage 4

Migration of Ca²⁺ and PO₄³-groups to the surface through the SiO₂ rich layer forming CaO—P₂O₅ rich film on top of the SiO₂ rich layer followed by growth of the amorphous CaO—P₂O₅ rich film by incorporation of soluble calcium and phosphate from solution.

Stage 5

Crystallisation of the amorphous CaO—P₂O₅ film by incorporating OH⁻ and CO₃²⁻ or F⁻ ions from solution to form a mixed hydroxyl-carbonate apatite (HCA) layer.

Stage 6

Agglomeration and chemical bonding of biological moieties within the growing HCA layer leading to the incorporation of collagen fibrils produced by osteoblasts or fibroblasts.

The first step involves the diffusion of sodium ions through the glass and their ion exchange for protons or hydrated protons with the consequent formation of silanol groups in the glass structure. This is followed by Step 2, the alkaline hydrolysis of Si—O—Si bonds of the glass network and the formation of a silica gel layer on the surface of the glass. This in turn is followed by precipitation and nucleation of a hydroxycarbonated apatite (HCA) layer which, along with the release of calcium and phosphate ions and the release of silicon, stimulates new bone formation. This mechanism is based on the corrosion behaviour of conventional glasses, and is not very predictive of the glass compositions that will give rise to bioactivity and this has inhibited the design and development of new bioactive glass compositions tailored to specific applications explain the dependence of bioactivity, as measured by the ability to form a hydroxycarbonated apatite (HCA) layer on the surface of the glass in simulated body fluid (SBF), on small changes in the molar percentage of silica in the glass composition. Furthermore, it is known that for invert glasses (defined as glasses where there is a greater mole percentage of network modifying oxides than network formers, which includes typical bioactive glass compositions) the degradation rate increases with reducing pH whereas the opposite is true for conventional glasses. This suggests that invert glasses have very different mechanisms of degradation from conventional glasses.

Thus, the deposition of a crystalline HCA layer on a glass on exposure to SBF can be used as a measure of Bioactivity. SBF can be prepared according to the method of Kokubo, T., et al, J. Biomed. Matter. Res., 1990, 24, P721-734. To prepare SBF the reagents below are added, in order, to deionise water to give a total SBF volume of 1 litre. All reagents were dissolved in 700 mls of deionised water and warmed to a temperature of 37° C. The pH is measured and HCA added to give a pH of 7.25 and the volume made up to 1000 ml with deionised water.
NaCl—7.996 g
NaHCO₃—0.350 g
KCl—0.224 g
K₂HPO₄.3H₂O—0.228 g
MgCl₂.6H₂O—0.305 g
1N HCL—35 ml
CaCl₂.2H₂O—0.368 g
Na₂SO₄—0.071 g
(CH₂OH)CNH₂—6.057 g

On exposure of a glass to SBF the deposition of an HCA layer can be monitored by x-ray powdered diffraction and fourrier transform infrared spectroscopy (FTIR). The appearance of hydroxy carbonated apatite peaks, characteristically at 2 theta values of 25.9, 32.0, 32.3, 33.2, 39.4 and 46.9 in an x-ray diffraction pattern is indicative of the formation of a HCA layer. The appearance of a P—O bend signal at a wavelength of 566 and 598 cm⁻¹ in an FTIR spectra is indicative of deposition of an HCA layer. A glass can be considered bioactive if, on exposure to SBF, deposition of an HCA layer is seen within three days.

A variety of techniques including solid state nuclear magnetic resonance spectroscopy, small angle neutron scattering, dielectric measurements of sodium ion diffusion and dissolution studies carried out by the inventors have shown:
i) that phosphorus-containing, melt-derived, bioactive glasses have undergone glass-in-glass phase separation to give a phosphate glass phase dispersed in a silicate glass phase;
ii) the activation for sodium ion diffusion is at least a factor of four higher than that for glass dissolution indicating that sodium ion diffusion is not the rate limiting step in glass degradation;
iii) after allowing for the glass-in-glass phase separation there is almost congruent dissolution of the glass;
iv) there is a good correlation between network connectivity and dissolution behaviour and bioactivity.

Consequently, the inventors have determined that step 2 of the accepted mechanism set out in Scheme 1 is not completely correct and that actually there is little or no Si—O—Si bond hydrolysis taking place. Based on these observations, the inventors developed a network connectivity model to predict bioactivity based on the model described in Hill R., J. Mater. Sci. Letts. 15 1122-25 (1996), but modified to take account of the phosphorus not being part of the silicate network. However, the inventors have determined that the bioactivity of glasses in the published literature, which contained MgO did not fit this modified network connectivity (NC) model. Such MgO-containing glasses were often less bioactive than predicted. See for example K. Wallace “Design of Novel Bioactive Glasses” Ph.D thesis, University of Limerick. (2000) which refers to glasses having the composition 49.46SiO₂:1.07P₂O₅:(36.27-X)CaO:XMgO:13.17Na₂O where X is 0, 3.63, 7.25 and 18.14.

This has led us to the novel finding reported here that in highly disrupted bioactive glasses of low network connectivity (corresponding to SiO₂ contents <60 mole %) a proportion of the MgO becomes incorporated into the silicate glass network and increases the network connectivity, rather than acting as a network modifier and disrupting the glass network according to established beliefs. Despite the initial data referred to above concerning phosphorus containing glass, this finding has been shown to be applicable both to phosphorus containing and non-phosphorus containing glasses.

When MgO is incorporated into the silicate network in this way it results in a reduction in the chemical shift of the solid state ²⁹Si spectra of the glass and an increase in the proportion of Q³ silicon at the expense of Q² silicon in the glass structure. A Q² silicon is a silicon with two non-bridging oxygen atoms and two bridging oxygen atoms, whilst a Q³ silicon corresponds to a silicon with one non-bridging oxygen and three bridging oxygen atoms: FIG. 1 shows a series of ²⁹Si spectra. Table 1 shows the proportions of Q² and Q³ and the NC obtained from deconvoluting the spectra:

TABLE 1

| % | | | | | | | | |
|---|---|---|---|---|---|---|---|---|
| MgO | P_{R} | P₁ | P₂ | Int₁ | Int₂ | Q₂ | Q₃ | NC |
| 0% | −81.88 | −81.89 | | 30.30 | 0 | 1.000 | | 2.00 |
| 25% | −83.08 | −81.60 | −90.75 | 16.90 | 7.477 | 0.70 | 0.30 | 2.31 |
| 50% | −84.58 | −81.53 | −91.41 | 13.35 | 10.92 | 0.55 | 0.450 | 2.45 |
| 75% | −83.68 | −81.16 | −86.28 | 10.75 | 31.70 | 0.25 | 0.75 | 2.75 |
| 100% | −89.08 | −81.89 | −93.24 | 8.17 | 27.21 | 0.23 | 0.77 | 2.77 |

FIG. 2 shows the NC calculated for this series of glasses plotted against the MgO content for instances where MgO acts as either i) a network modifying oxide ii) an intermediate oxide or iii) where 17% of the MgO acts as an intermediate oxide. It can be seen that the network connectivity calculated assuming 17% of the MgO is acting as an intermediate oxide fits the observed experimental data well. In glasses with lower network connectivity the percentage of MgO acting as an intermediate oxide increases substantially. The increase in the network connectivity accompanying substitution of MgO for CaO and the formation of Q³ silicon would be expected to decrease the reactivity of the glass since MgO is acting to crosslink the glass network. However, the introduction of Mg—O—Si bonds into the glass network is thought to provide bonds capable of undergoing acid hydrolysis, thereby providing an additional glass dissolution route via hydrolysis of Mg—O—Si bonds, in an analogous manner to incorporating Al₂O₃ in conventional fluoro-alumino-silicate glasses for forming glass (ionomer) polyalkenoate cements. In these fluoro-alumino-silicate glasses acid degradability is determined largely by the number of Al—O—Si bonds in the glass network and therefore by the ratio of Al:Si in the glass composition. The network connectivity is of secondary importance. Similarly, acid degradability and consequently suitability of a MgO containing glass for use in poly(carboxylic acid) cement formation, is determined by the ratio of Mg:Si in the glass composition.

It should be noted that although poly(carboxylate) cements based on ZnO—SiO₂ glasses with typically <55 mole % SiO₂ are known, to date the reactivity of such glasses has been explained solely on the basis of their network connectivity.

Zn²⁺ has a similar charge to size ratio as Mg²⁺ and some ZnO can be incorporated into glasses of the invention, to perform a corresponding role to MgO. Therefore, in silicate glasses of the present invention the acid degradability is determined by the network connectivity and also by the ratio of Mg:Si (and, if included, Zn:Si). The number of acid hydrolysable Mg—O—Si bonds and Zn—O—Si bonds in the glass network provides an important glass degradation mechanism aiding cement formation. However, the amount of ZnO in a glass must be kept low. Prior art zinc silicate glasses used for cement formation with polycarboxylic acids have typically >20 mole percent ZnO but ZnO at these high levels inhibits HCA formation from SBF (i.e. bioactivity). Additionally, zinc is appreciably toxic at even quite modest concentrations. The concentration of magnesium found in body fluids is considerably higher than that of zinc and magnesium is not generally regarded as toxic. For this reason it is preferable to include MgO rather than ZnO, although ZnO may be included at modest levels for its biological benefit in stimulating wound healing in individuals with low blood plasma zinc levels.

A further benefit of incorporating MgO instead of CaO results from the higher charge to size ratio of Mg²⁺ relative to Ca²⁺. This provides for greater ionic interaction with carboxylate ions and increases the hydrolytic stability of cements formed in combination with polycarboxylic acids.

Results confirming the conclusions regarding MgO acting as an intermediate oxide were generated from studies of a series of glasses having the composition 3SiO₂:0.07 P₂O₅:(3-x-y)CaO:xMgO:yNa₂O and more specifically 49.46SiO₂:1.07P₂O₅:(23.08-x)CaO:xMgO:26.38Na₂O, wherein x is 0, 5.77, 11.54, 17.31 and 23.08. These studies included density studies, studies of T_{g} and Tₛ, TEC studies and ³¹P and ²⁹Si MAS studies. In these studies, increasing oxygen density and decreasing T_{g} and Tₛ with Mg substitution were observed, both of which support Mg²⁺ entering the glass network. ³¹P and ²⁹Si MAS studies showed little indication of magnesium participating in the phosphate phase, supporting its activity as an intermediate oxide, reducing its ability to participate in the phosphate phase.

### EXAMPLES

Examples of the glass compositions according to the present invention that have been prepared and used to form polycarboxylate cements are given in Table 2.

Cements are formed by combining a glass of the invention, as exemplified in Table 2 with synthetic polycarboxylic acids such as those described in the art (e.g U.S. Pat. No. 4,209,434). For example, polymers based on acrylic acid, maleic acid, itaconic acid as well as polymers based on phosphoric acids such as poly(vinylphosphonic acid) and related polymers are known and any copolymer combinations of the above may form a stable non-degradable cement suitable for medical application as a bone cement or bone substitute. The polyacid should preferably have a molecular weight greater than 2,000 and preferably less than 200,000 and more preferably 20,000 to 100,000. Cements may also be formed with low molar mass, multifunctional carboxylic acids such as tartaric acid and citric acid or their mixtures with polycarboxylic acids.

Biodegradable cements suitable for medical application may be formed with glass compositions described in Table 2 together with poly(gamma glutamic acid), a water soluble polypeptide synthesised by bacteria and having a molecular weight between 2,000 and 400,000 (preferably between 10,000 and 200,000).

It will be appreciated the glass compositions within Table 2 in which the content of MgO is 20 mol % or less are provided for comparative purposes.

TABLE 2
Glass compositions and melting temperatures

| | | | | | | | | | | | Melting |
|---|---|---|---|---|---|---|---|---|---|---|---|
| Example | SiO₂ | P₂O₅ | CaO | SrO | MgO | ZnO | Na₂O | K₂O | CaF₂ | SrF₂ | Temp. (° C.) |
| 1 | 50 | 0 | 44 | 0 | 0 | 0 | 6 | 0 | 0 | 0 | 1460 |
| 2 | 50 | 0 | 33 | 0 | 11 | 0 | 6 | 0 | 0 | 0 | 1460 |
| 3 | 50 | 0 | 22 | | 22 | 0 | 6 | 0 | 0 | 0 | 1460 |
| 4 | 50 | 0 | 11 | | 33 | 0 | 6 | 0 | 0 | 0 | 1460 |
| 5 | 50 | 0 | 0 | | 44 | 0 | 6 | 0 | 0 | 0 | 1460 |
| 6 | 45 | 0 | 49 | | 0 | | 6 | | | | 1460 |
| 7 | 45 | 0 | 24.5 | | 24.5 | | 6 | | | | 1400 |
| 8 | 45 | 0 | 12 | 0 | 37 | 0 | 6 | | | | 1400 |
| 9 | 45 | 0 | 6 | 6 | 32 | 5 | 6 | | | | 1470 |
| 10 | 45 | 0 | 10 | 10 | 24 | 5 | 6 | | | | 1470 |
| 11 | 49.46 | 1.07 | 10.47 | | 33 | 0 | 6 | 0 | | | 1450 |
| 12 | | | | | | | | | | | |
| 13 | 50 | 1 | 10 | 10 | 21 | 4 | o | 0 | 0 | 4 | 1400 |
| 14 | 50 | 1 | 20 | 0 | 21 | 4 | o | 0 | 0 | 4 | 1450 |
| 15 | 50 | 1 | 0 | 20 | 21 | 4 | o | 0 | 0 | 4 | 1450 |
| 16 | 43.93 | 1.07 | 6.25 | | 36.75 | | | | 12.00 | | 1400 |
| 17 | 43.93 | 1.07 | 3.13 | 3.13 | 36.75 | | | | 6.00 | 6.00 | 1400 |
| 18 | 43.93 | 1.07 | 12.00 | 6.25 | 36.75 | | | | | 12.00 | 1440 |
| 19 | 43.93 | 1.07 | 6.25 | 12.00 | 36.75 | | | 6.25 | | | 1400 |
| 20 | 43.93 | 1.07 | 15.13 | | 36.75 | | | 3.33 | | | 1400 |
| 21 | 42.13 | 2.05 | 16.04 | | 36.78 | | | | 3.00 | | 1440 |
| 22 | 37.51 | 4.57 | 18.40 | | 36.86 | | | | 2.67 | | 1400 |
| 23 | 43.93 | 1.07 | 15.13 | | 36.75 | | | | 3.13 | | 1400 |
| 25 | 50.50 | | 10.88 | | 32.63 | | | | 6.00 | | 1400 |
| 26 | 50.00 | | 11.00 | | 33.00 | | | | 6.00 | | 1400 |
| 27 | 49.5 | | 11.13 | | 33.38 | | | | 6.00 | | 1400 |
| 28 | 49 | | 11.00 | | 33.75 | | | | 6.00 | | 1400 |
| 29 | 46.3 | 1.07 | 15.13 | | 33.31 | 1.07 | | | 3.13 | | 1400 |
| 30 | 46.3 | 1.07 | 10.08 | 5.04 | 33.31 | 1.07 | | | 2.08 | 1.56 | 1400 |
| 31 | 46.3 | 1.07 | 7.56 | 7.56 | 33.31 | 1.07 | | | 1.56 | 2.08 | 1400 |
| 32 | 46.3 | 1.07 | | 15.13 | 33.31 | 1.07 | | | | 3.13 | 1400 |

Glass Synthesis Method

A series of glasses based on the series 50SiO₂:44-XCaO:6Na₂O:XMgO and as represented by examples 1 to 5 in Table 2 was synthesised by a melt quench route. This route is set out for glass example 1 below. The glasses were ground to a fine powder and their ²⁹Si MAS-NMR spectra were obtained.

### Example 1

High purity quartz sand (75 g) of particle size less than 200 microns, 110 g of calcium carbonate 9.3 g and sodium carbonate are mixed together thoroughly in a sealed plastic container. Then the mixture is placed in platinum crucible in a furnace at 1480° C. for 1.5 hours. The resulting molten glass is poured into 200 litre of deionised water to produce a granular glass frit, which is dried at 120° C. for one hour. The glass frit is then milled and sieved through a 38 micron sieve to give a glass powder with a mean particle size of about 5 microns.

This procedure was repeated with appropriate glass components to produce the glasses of examples 1 to 5.

### Cement Formation Examples

Cement 1

A glass powder (1.1 g) of example 1 was mixed with poly(acrylic acid) (0.5 g) of nominal molar mass 90,000. This mixture was then mixed with deionised water (0.5 g) on a glass slab and the resulting cement paste set in approximately 3 minutes. It was placed in a cylindrical mould of 6 mm height and 4 mm in diameter and then put in an oven at 37° C. for one hour. The cement was then removed from the mould and placed in deionised water at 37° C. It dissolved in less than 24 hours.

Cement 2

The Cement 1 procedure was repeated with a glass of example 4 but 1.8 g of glass was used instead of 1.1 g. Note that because of the differing reactivity of the glass it is not possible to mix at the same ratios. The cement cylinder was found to be hydrolytically stable and was still an intact cylinder after 24 hours immersion in deionised water at 37° C.

These two examples demonstrate the importance of having MgO in the cement formulation with regard to the hydrolytic stability of the cement.

Cements made with glass example 2 were not hydrolytically stable, behaving like cement 1. Cements made with Glass Example 3 were more hydrolytically stable, but still not fully stable in water.

Cement 3

A glass of example 8, with a lower SiO₂ mole percent of 45 mole %, was mixed with poly(acrylic acid) as in cement examples 1 and 2, but the mixture reacted rapidly before it was able to be mixed completely and the cement paste became hot. The acid-base reaction occurring in cement formation is exothermic. If the glass is highly disrupted or basic the reaction will occur faster causing heat generation to be more noticeable.

In an alternative approach in order to reduce the reaction rate, the glass powder was placed in a small crucible and heated to the experimentally determined glass transition temperature, held for one hour and the furnace switched off. This glass powder was then much less reactive and used to make a cement with poly(acrylic acid) as before. Following this annealing process, the cement reaction was sufficiently slow to enable the cement to be mixed thoroughly before the setting process occurred. Generally glasses with lower NC values are more reactive and will benefit from annealing prior to cement formation.

Cements 4-11

Cements were prepared with the following compositions. The setting and working times of the various prepared cements were measured using an oscillating rheometer. In addition, the hydrolytic stability of the cements was assessed by emersion of the cements in water for one week.

The oscillating rheometer functions by having one plate fixed and one rotating through an angle of about 30 degrees. The amplitude of the oscillation is measured as a function of time. The cement paste is placed between the two plates. Initially the cement is fluid and does not influence the amplitude of the oscillation. As the cement starts to thicken and the viscosity increase the oscillation decreases. The working time is taken as the time to reach 95% of the amplitude of the initial oscillation and the setting time as the time to reach 5% of the initial oscillation.

Whilst depending on the intended application for a cement, typically working times of 2-20 minutes are desired. It should be noted that generally adding Na₂O extends working and setting times.

Cement 4, comprising glass example 21:

0.3 Annealed glass:0.1 PAA (poly acrylic acid):0.15 Liquid (Water with 20% (+) tartaric acid)

Glass reactivity changes hugely with small changes in composition for glasses with NC values close to 2.0 and it can be difficult to control viscosity and cement setting. Tartaric acid increases the acid concentration but, unlike adding more polyacrylic acid, does not increase the viscosity, enabling a good cement paste to be formed,

Cement 5, comprising glass example 22:

0.3 Glass:0.1 PAA:0.15 Liquid (Water with 50% (+) tartaric acid)

The working time of cement 5 was just enough to be able to shape a ball of cement. After one week in water, the water is optically clear and the cement does not have rubbery behaviour. Glass composition 22, used in cement 5, is interesting because the glass reactivity was ideal for cement formation and it was possible to work on the cement without annealing the glass.

Cement 6, comprising glass example 23:

0.3 Annealed Glass:0.1 PAA:0.15 Liquid (Water with 50% (+) tartaric acid)

Cement 6 showed stability in water (water optically clear, cement is hard after one week immersion).

Cements 7-10 comprising glass examples 24, 25, 26 and 27: Cements were prepared with each of glasses 24, 25, 26 and 27, with the composition: 0.3 Glass:0.1PAA:0.15 Liquid (Water)

These glasses became much more reactive with reducing silica content, with reducing working and setting times demonstrating the importance of NC on glass reactivity (Table 3).

Changes in cement working time are determined by NC and the amount of MgO that switches its role in the glass structure.

Cements 7-10 exhibited high compressive strengths after 24 hours but these compressive strengths reduced significantly on immersion in water. The results are shown in FIG. 4.

TABLE 3
Setting and Working Times of Cement Pastes as Determined by
Oscillating Rheometry. The definitions of the working and setting
times are defined on a typical trace shown in FIG. 3 The technique
is described by Griffin and Hill (Griffin S. and Hill R. G. “Influence
of glass composition on the properties of glass polyalkenoate
cements: Part I influence of aluminium to silicon ratio” Biomaterials
20 (1999) 1579-1586).

| Cement Example | Working Time (s) | Setting Time (mins) |
|---|---|---|
| 1 | 40 | 3.5 |
| 2 | 30 | 3.1 |
| 3 | <<30 | — |
| 3 annealed | 30 | 2.5 |
| 4 | 40 | 8.6 |
| 5 | 30 | 4.2 |
| 6 | 36 | ? |
| 7 | 30 | 5.0 |
| 8 | 75 | 4.0 |
| 9 | <30 | — |
| 10 | <30 | — |

It should be understood that the invention is susceptible to various modifications and alternative forms. The invention is not to be limited to the particular forms disclosed, but should cover all modifications, equivalents and alternatives falling within the spirit of the disclosure.

1. A poly(carboxylic acid) cement formed from a water soluble poly(carboxylic acid) and an aluminium-free glass comprising SiO₂ and MgO, wherein within the glass the molar percentage of SiO₂ does not exceed 60% and the molar percentage of MgO is greater than 20%.

2. The poly(carboxylic acid) cement of claim 1, wherein the poly(carboxylic acid) is a synthetic poly(carboxylic acid), selected from a poly(acrylic acid), poly(aspartic acid), poly-(glutamic acid), poly(maleic acid), poly(itaconic acid), poly(vinyl phosphonic acid) or any copolymer poly(carboxylic acid) based on two or more of the above.

3. The poly(carboxylic acid) cement of claim 1, wherein the poly(carboxylic acid) is poly(gamma glutamic acid).

4. The poly(carboxylic acid) cement of claim 1, wherein the cement is a degradable cement formed from poly(gamma glutamic acid) of molar mass >100,000 in combination with one or more multi functional poly(carboxylic acids) of molar mass less than 15,000.

5. An aluminium-free glass for use in the formation of a poly (carboxylic acid) cement, the glass comprising
30-60 mol % SiO₂,
21-50 mol % MgO,
0-6 mol % Na₂O,
a combined content of CaO and SrO of 0-40 mol %, and
0-5 mol % P₂O₅.

6. The glass of claim 5, comprising 40-55 mol % SiO₂.

7. The glass of claim 5, comprising 21-40 mol % MgO.

8. The glass of claim 5, comprising a combined content of CaO and SrO of 10-30 mol %.

9. The glass of claim 5, wherein the glass is a melt-derived glass with a molar percentage of SiO₂ that does not exceed 53%.

10. The glass of claim 5 having an NC below 3.0.

11. The glass of claim 5, wherein the glass is a bioactive glass.

12. The glass of claim 5, comprising one or more additional components selected from a source of strontium, calcium, phosphate, zinc, fluorine, boron or an alkali metal such as sodium or potassium.

13. The glass of claim 12, wherein the glass comprises no sodium and a source of fluorine not exceeding 10 mol %.

14. The glass of claim 5, having the molar composition YSiO₂:(Z—X)CaO+SrO:XMgO:6Na₂O, wherein X is more than 20, Y is 45-50 and Z is 44-49.

15. The glass of claim 14, having the composition 45SiO₂:(49-X)CaO+SrO:XMgO:6Na₂O or 50SiO₂:(44-X)CaO:XMgO:6Na₂O.

16. A glass according to claim 5 which is provided in particulate form.

17. A poly(carboxylic acid) cement according to claim 1, wherein the aluminium-free glass comprises:
30-60 mol % SiO₂,
21-50 mol % MgO,
0-6 mol % Na₂O,
a combined content of CaO and SrO of 0-40 mol %, and
0-5 mol % P₂O₅.

18. The poly(carboxylic acid) cement of claim 1, wherein the cement comprises a water soluble antibiotic and/or a biological therapeutic agent.

19. (canceled)

20. A method for preparing a poly(carboxylic acid) cement as defined in claim 1 comprising mixing an aluminium-free glass comprising SiO₂ and MgO, wherein within the glass the molar percentage of SiO₂ does not exceed 60% and the molar percentage of MgO is greater than 20%, in powder form, with a water soluble poly(carboxylic acid) in the presence of water.

21. The method of claim 20, wherein the ratio by mass of poly(carboxylic acid) to water is at least 1:9 and less than 2:1.

22. The method of claim 21, wherein the glass comprises:
30-60 mol % SiO₂,
21-50 mol % MgO,
0-6 mol % Na₂O,
a combined content of CaO and SrO of 0-40 mol %, and
0-5 mol % P₂O₅.

23. The method of claim 20, wherein the ratio by mass of glass to poly(carboxylic acid) is at least 1:2 and less than 20:1.

24. A degradable scaffold comprising a cement as defined in claim 1, wherein 0.1 to 5% by weight of a metal carbonate, is added to the glass powder, prior to forming the cement in order to generate carbon dioxide and produce a foamed cement with interconnected pores of size greater than 100 microns.

25. (canceled)
